(19) United States
(12) Patent Application Publication
(10) Pub. No.: US 2016/0030984 A1
(43) Pub. Date: Feb. 4, 2016

(54) CHANNEL CLEANING SHUTTLE AND METHOD OF USE

(71) Applicants: Robert Rife, Mt. Pleasant, SC (US); Roger Rife, St. Mary's, GA (US)

(72) Inventors: Robert Rife, Mt. Pleasant, SC (US); Roger Rife, St. Mary's, GA (US)

(21) Appl. No.: 14/812,840

(22) Filed: Jul. 29, 2015

Related U.S. Application Data
(60) Provisional application No. 62/030,643, filed on Jul. 30, 2014.

(51) Int. Cl. B08B 9/049; F16L 55/46

(52) U.S. Cl. CPC B08B 9/049; F16L 55/46

(57) ABSTRACT

A cleaning shuttle is conveyed through a channel by magnetic attraction to a conveyance device that is slidably positioned outside the channel. The conveyance device pulls the cleaning shuttle through the channel by magnetic attraction between the conveyance device and the cleaning shuttle. The cleaning shuttle inside the channel, and the conveyance device positioned outside the channel, have significant magnetic attraction for each other, so that the cleaning shuttle is pulled through the channel by conveyance device without becoming lodged or stuck in the channel.

### FIELD OF THE INVENTION

This invention relates to devices and methods of cleaning small channels of instruments, such as, but not limited to, medical instruments.

### BACKGROUND OF THE INVENTION

Devices having small channels or lumens are used to transport materials from one location to another. Such devices are used to transport fluids which may include hazardous or dangerous materials, including solid matter that is conveyed by fluid flow. An example is medical instruments such as scopes that are used to view, biopsy, irrigate or evacuate body cavities.

After use, medical instruments are considered to be biohazards, and must be thoroughly cleaned before being used again. Cleaning includes disinfection or sterilization, which commonly involves cleaning and disinfecting fluids that are conveyed through the small channels of the instrument. However, solid materials, such as tissue, may be present in the channels, due to being trapped in the channels, or sticking within the channels. Trapped or stuck solid materials must be removed by mechanical force.

Currently, cleaning brushes that resemble small bottle brushes are conveyed through channels in the scope. Channels of medical instruments may have a substantial length. Clearing brushes for this purpose must have a long, wire handle which makes the brushes awkward to handle, difficult to store and cumbersome to clean. There is a need for a mechanical cleaning device for small channels of devices and instruments that have such channels. The device should not be of a length that makes handling of the device cumbersome or difficult.

### SUMMARY OF THE INVENTION

The present invention is a cleaning shuttle that is conveyed through a channel by magnetic attraction to a conveyance device that is slidably positioned outside the channel. The conveyance device pulls the cleaning shuttle through the channel by magnetic attraction. The cleaning shuttle inside the channel, and the conveyance device positioned outside the channel, have significant magnetic attraction for each other so that the cleaning shuttle is pulled through the channel by conveyance device without becoming lodged or stuck in the channel.

### BRIEF DRAWING DESCRIPTION

FIG. 1 shows a cleaning shuttle according to an embodiment of the invention.

FIG. 2 is a front elevation of an embodiment of a conveyance device according to an embodiment of the invention.

FIG. 3 is a top view of the conveyance device according to the embodiment of FIG. 2.

FIG. 4 shows an example of a bronchoscope.

FIG. 5 shows the bronchoscope of FIG. 4 with the cleaning shuttle of FIG. 1 positioned in a channel or lumen of the bronchoscope.

FIG. 6 shows the bronchoscope of FIG. 5 with the conveyance device positioned on an exterior of the bronchoscope and adjacent to the channel.

FIG. 7 demonstrates the cleaning shuttle being transported through the channel of the bronchoscope of FIG. 5 by the conveyance device.

### DESCRIPTION OF PREFERRED EMBODIMENTS

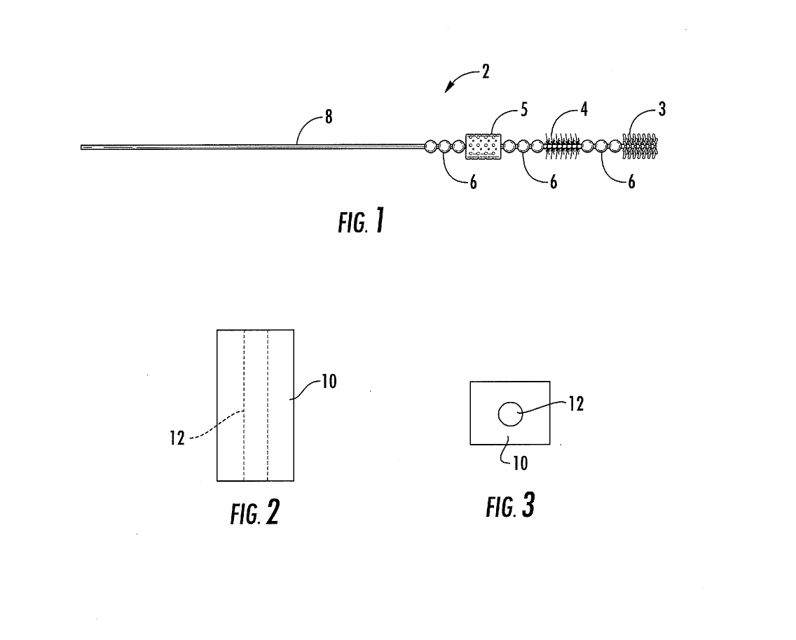

FIG. 1 shows a cleaning shuttle 2 according an embodiment of the present invention. A length of the cleaning shuttle comprises cleaning members, which may be a brush having bristles 4, or a softer or absorbent material such as a sponge 5. The bristles are sized according to the application, so that the bristles are in contact with a channel or channels of the device to be cleaned, without being so large as to lodge or stick within the channel. The bristles are similar to bristles currently used for bottle brushes or brushes that are used to clean small channels.

Interspersed among the bristles on the elongated member are a plurality of transport members 6 having a ferrous component, or alternatively, a magnetic component. These members may be a plurality of spherical or cylindrical members that will pass through the channel of the object being cleaned. The spherical members may be stainless steel ball bearings having a void through the members, like a bead, so that a flexible and elongated portion 8 of the cleaning shuttle passes through the central void of the ball. Alternatively, the transport members 6 may be a plurality of small cylinders that will pass through a generally round cross section of the channel being cleaned, with the cylinders having a central void through which the elongated member of the cleaning shuttle pass. The spherical, cylindrical or other suitably shaped ferrous or magnetic members alternate with the bristles of the cleaning shuttle in a preferred embodiment. The bristles are attached to the elongated member to form the cleaning shuttle 2.

In an embodiment, a first cleaning member 3 differs in structure and texture from a second cleaning member 4. A third cleaning member 5, if used, differs in structure and texture from the first and cleaning member. For example, a first set of bristles is coarse, or even abrasive. A second set of bristles may be finer, and perhaps more densely spaced than the second set. A third cleaning may be an absorbent material, such as a sponge or a textile or other absorbent material. The first set of bristles breaks away solid material; the more densely spaced set of bristles cleans finer particles; and the absorbent material absorbs liquids and solids that are carried by liquid material, and further, cleans even finer particles. In another embodiment, each of the cleaning members is formed of the same materials or bristle structure.

FIG. 2 and FIG. 3 show a conveyance device 10. The conveyance device conveys the cleaning shuttle 2 through an appropriate channel by magnetic attraction with the steel balls, cylinders, or similar members 6 of the cleaning shuttle. The conveyance device is a magnet, or comprises a magnet, having a magnetic attraction or affinity for the members 6 of the cleaning shuttle. The conveyance device in the embodiment shown in FIG. 3, when viewed from the top, may be a block having a center channel 12 or lumen formed therein that receives the appropriate part of a device or instrument to be cleaned. The exterior shape of the conveyance device is generally not critical, and could be a cylinder, or ovoid shape when viewed from the top, or an irregular shape. The exterior may have pistol grip or similar formation to assist gripping of the conveyance member.

The conveyance member may be formed in two pieces that split the channel 12 to assist placement of the device over a channel of the instrument to be cleaned. This may be important if the instrument has parts that are larger than the center channel or lumen of the conveyance device that obstruct placement of the conveyance device. The two pieces may be connected by magnetic attraction to each other, or alternatively, or additionally, the two pieces may be hinged for separation and subsequent reattachment of the conveyance device around the channel.

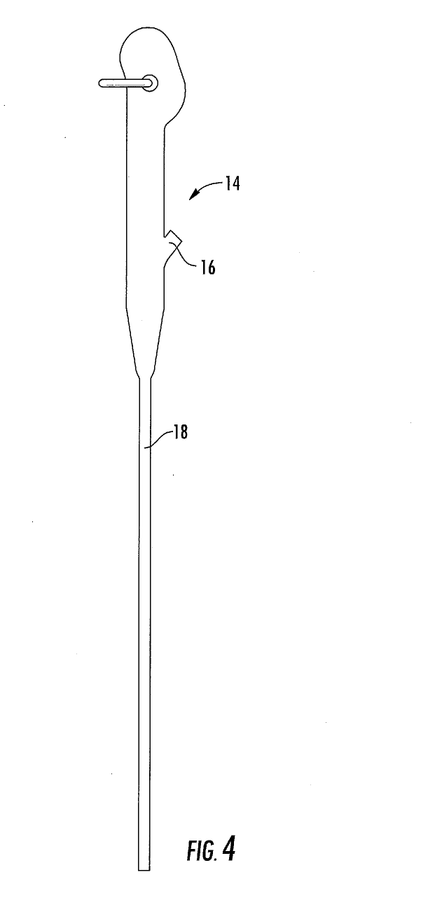

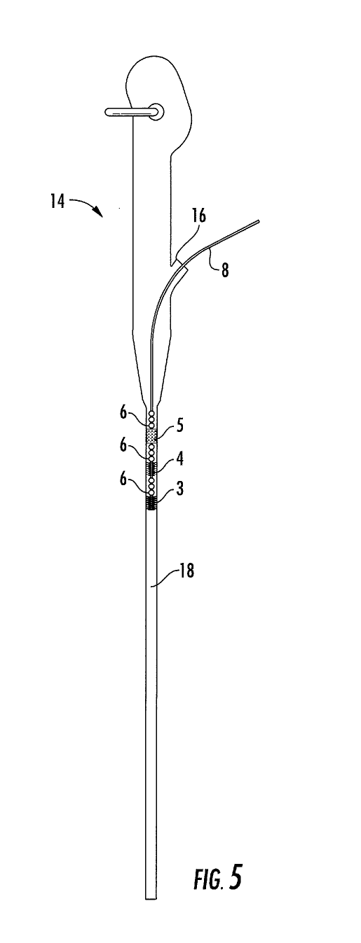

FIG. 4 shows a simple embodiment of a medical device having a channel. The device shown is representative of a bronchoscope 14, although endoscopes and other types of scopes having channels may be cleaned with the device according to the invention. As shown in FIG. 4, the bronchoscope has a port 16 that intersects and communicates with a channel such as lumen 18 of the bronchoscope. The lumen is used to transport devices and/or materials, such as fluids or gases, into and out of a human or animal body.

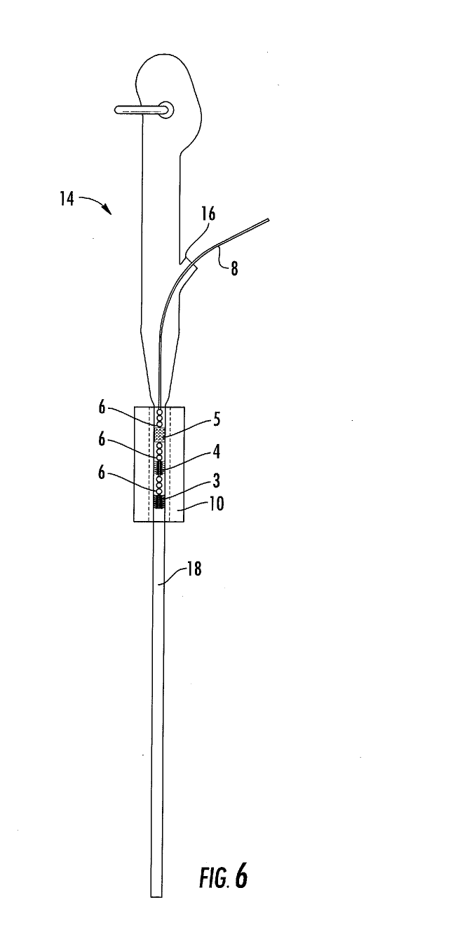

FIG. 5 shows the bronchoscope of FIG. 4 with the cleaning shuttle 2 inserted into the port. FIG. 5 demonstrates the bristles of the cleaning shuttle being fully inserted into the channel of the bronchoscope according to a preferred embodiment of the invention, with the cleaning shuttle having flexible elongated member 8 acting as a handle for a positioning the cleaning shuttle. FIG. 5 and FIG. 7 demonstrate that the cleaning shuttle need not have a length that is as long as the length channel or lumen of the bronchoscope or other device to be cleaned.

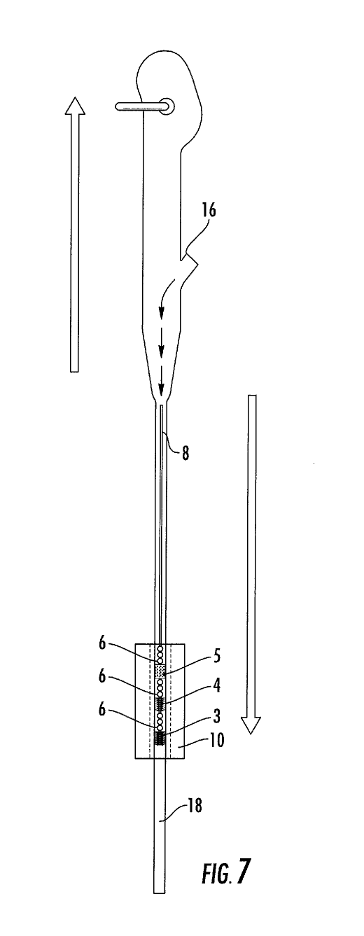

FIG. 6 shows the conveyance member 10 positioned on an exterior of the bronchoscope or other device to be cleaned. The conveyance member is positioned over the cleaning shuttle 2 and the bronchoscope. More particularly, the conveyance member is positioned over the bristle portion of end of the cleaning shuttle, with magnetic attraction established tween the cleaning shuttle and the conveyance device.

FIG. 7 demonstrates conveyance of the cleaning shuttle through the channel or lumen of the bronchoscope or other device by movement of the conveyance device along the length of the channel 18 of the scope. The conveyance device may be moved up or down within the channel or lumen, transporting the magnetically attracted cleaning shuttle up or down in the lumen as the conveyance member is moved relative to the scope. The conveyance device may be moved up or down multiple times in a cleaning cycle as determined to be appropriate by the operator to remove debris from the channel.

The device according to the invention may be used in the presence of cleaning fluids or disinfectants to improve the efficacy of the operation. The bristles 3,4 and the plurality of transport members 6 may be formed to allow such cleaning or disinfecting fluids to flow past the cleaning members and through the cleaning shuttle and within the channel or lumen of the scope.

The magnetic attraction between the cleaning shuttle and the conveyance member should be sufficient to transport the cleaning shuttle in the presence of resistance presented by tissue or other solid materials present in the channel of the scope. In one embodiment, the conveyance member is an electromagnet that provides additional magnetic attraction to the cleaning shuttle.

What is claimed:

1. A method of cleaning an instrument having channels therein, comprising the steps of:
a) inserting a cleaning shuttle into an opening of a channel of an instrument;
b) surrounding the channel of the instrument on an exterior of the instrument with a conveyance device;
c) progressively moving the conveyance device along the exterior the instrument, causing the cleaning shuttle to progress along the channel of the instrument to clean the channel, wherein conveyance is by magnetic attraction between the cleaning shuttle and the conveyance device;
wherein the cleaning shuttle comprises a plurality of spaced apart transport members affixed to an elongated member, wherein the cleaning shuttle comprises a plurality of cleaning members extending outwardly from the elongated member along a length of the elongated member and with cleaning members extending outwardly from between adjoining spaced apart transport members, and wherein the spaced apart transport members are magnetically attracted to the conveyance device.

2. A method of cleaning an instrument having channels therein as described in claim 1, wherein the spaced apart transport members are cylindrical in shape.

3. A method of cleaning an instrument having channels therein as described in claim 1, wherein the spaced apart transport members are cylindrical in shape.

4. A method of cleaning an instrument having channels therein as described in claim 1, wherein a cross section of the elongated member has no dimension that is larger than a cross section of the channel.

5. A method of cleaning an instrument having channels therein as described in claim 1, wherein the conveyance device is an electromagnet.

6. A method of cleaning an instrument having channels therein as described in claim 1, wherein the cleaning shuttle is pulled through to an opening in an opposite end of the channel by the conveyance device.

7. A method of cleaning an instrument having channels therein as described in claim 1, wherein the cleaning shuttle is twice pulled through the entire length of channel by the conveyance device.

8. A method of cleaning an instrument having channels therein as described in claim 1, wherein the conveyance device is formed in two pieces.

9. A method of cleaning an instrument having channels therein as described in claim 1, wherein the conveyance device is formed in two pieces, wherein the two pieces are magnetically attracted to each other.

10. A method of cleaning an instrument having channels therein as described in claim 1, further comprising the step of introducing disinfectant fluid into the channel, wherein the disinfectant fluid is present during the step of the cleaning shuttle progressing along the channel.

11. A method of cleaning an instrument having channels therein as described in claim 1, wherein a cleaning member of the cleaning members comprises bristles.

12. A method of cleaning an instrument having channels therein as described in claim 1, wherein a cleaning member of the cleaning members comprises an absorbent material.

13. A method of cleaning an instrument having channels therein as described in claim 1, wherein a first cleaning member of the cleaning members comprises bristles and a second cleaning member of the cleaning members comprises an absorbent material.

14. A method of cleaning an instrument having channels therein as described in claim 1, wherein a first cleaning member of the cleaning members comprises coarse bristles and a second cleaning member of the cleaning members comprises finer bristles than the first member, and a third member of the cleaning members comprises an absorbent material.
